(19) United States
(12) Patent Application Publication
(10) Pub. No.: US 2011/0091055 A1
(43) Pub. Date: Apr. 21, 2011

(54) LOUDSPEAKER LOCALIZATION TECHNIQUES

(75) Inventor: Wilfrid LeBlanc, Vancouver (CA)

(73) Assignee: BROADCOM CORPORATION, Irvine, CA (US)

(21) Appl. No.: 12/637,137

(22) Filed: Dec. 14, 2009

Related U.S. Application Data
(60) Provisional application No. 61/252,796, filed on Oct. 19, 2009.

(51) Int. Cl. H04R 5/02; H04R 29/00

(52) U.S. Cl. 381/303; 381/59

(57) ABSTRACT

Techniques for loudspeaker localization are provided. Sound is received from a loudspeaker at a plurality of microphone locations. A plurality of audio signals is generated based on the sound received at the plurality of microphone locations. Location information is generated that indicates a loudspeaker location for the loudspeaker based on the plurality of audio signals. Whether the generated location information matches a predetermined desired loudspeaker location for the loudspeaker is determined. A corrective action with regard to the loudspeaker is enabled to be performed if the generated location information is determined to not match the predetermined desired loudspeaker location for the loudspeaker.

This application claims the benefit of U.S. Provisional Application No. 61/252,796, filed on Oct. 19, 2009, which is incorporated by reference herein in its entirety.

### BACKGROUND OF THE INVENTION

1. Field of the Invention

The present invention relates to loudspeakers and acoustic localization techniques.

2. Background Art

A variety of sound systems exist for providing audio to listeners. For example, many people own home audio systems that include receivers and amplifiers used to play recorded music. In another example, many people are installing home theater systems in their homes that seek to reproduce movie theater quality video and audio. Such systems include televisions (e.g., standard CRT televisions, flat screen televisions, projector televisions, etc.) to provide video in conjunction with the audio. In still another example, conferencing systems exist that enable the live exchange of audio and video information between persons that are remotely located, but are linked by a telecommunications system. In a conferencing system, persons at each location may talk and be heard by persons at the locations. When the conferencing system is video enabled, video of persons at the different locations may be provided to each location, to enable persons that are speaking to be seen and heard.

A sound system may include numerous loudspeakers to provide quality audio. In a relatively simple sound system, two loudspeakers may be present. One of the loudspeakers may be designated as a right loudspeaker to provide right channel audio, and the other loudspeaker may be designated as a left loudspeaker to provide left channel audio. The supply of left and right channel audio may be used to create the impression of sound heard from various directions, as in natural hearing. Sound systems of increasing complexity exist, including stereo systems that include large numbers of loudspeakers. For example, a conference room used for conference calling may include a large number of loudspeakers arranged around the conference room, such as wall mounted and/or ceiling mounted loudspeakers. Furthermore, home theater systems may have multiple loudspeaker arrangements configured for “surround sound.” For instance, a home theater system may include a surround sound system that has audio channels for left and right front loudspeakers, an audio channel for a center loudspeaker, audio channels for left and right rear surround loudspeakers, an audio channel for a low frequency loudspeaker (a “subwoofer”), and potentially further audio channels. Many types of home theater systems exist, including 5.1 channel surround sound systems, 6.1 channel surround sound systems, 7.1 channel surround sound systems, etc.

As the complexity of sound systems increases, it becomes more important that each loudspeaker of a sound system be positioned correctly, so that quality audio is reproduced. Mistakes often occur during installation of loudspeakers for a sound system, including positioning loudspeakers to far or too near to a listening position, reversing left and right channel loudspeakers, etc. As such, techniques are desired for verifying proper positioning of loudspeakers, and for remedying the placement of loudspeakers determined to be improperly positioned.

### BRIEF SUMMARY OF THE INVENTION

Methods, systems, and apparatuses are described for performing loudspeaker localization, substantially as shown in and/or described herein in connection with at least one of the figures, as set forth more completely in the claims.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows a block diagram of an example sound system.

FIG. 2 shows a block diagram of an audio amplifier, according to an example embodiment.

FIGS. 3 and 4 show block diagrams of example sound systems that implement loudspeaker localization, according to embodiments.

FIG. 5 shows a flowchart for performing loudspeaker localization, according to an example embodiment.

FIG. 6 shows a block diagram of a loudspeaker localization system, according to an example embodiment.

FIGS. 7 and 8 shows block diagrams of sound systems that include example microphone arrays, according to embodiments.

FIG. 9 shows the sound system of FIG. 3, with a direction of arrival (DOA) and distance indicated for a loudspeaker, according to an example embodiment.

FIGS. 10-12 show block diagrams of audio source localization logic, according to example embodiments.

FIG. 13 shows a block diagram of a loudspeaker localization system with a user interface, according to an example embodiment.

FIG. 14 shows a block diagram of a sound system that has audio channels for left and right loudspeakers reversed.

FIG. 15 shows a process for detecting and correcting reversed loudspeakers, according to an example embodiment.

FIG. 16 shows a block diagram of a sound system where a loudspeaker has been incorrectly distanced from a listening position.

FIG. 17 shows a process for detecting and correcting an incorrectly distanced loudspeaker, according to an example embodiment.

FIG. 18 shows a block diagram of a sound system where a loudspeaker has been positioned at an incorrect angle from a listening position.

FIG. 19 shows a process for detecting and correcting a loudspeaker positioned at an incorrect angle from a listening position, according to an example embodiment.

FIG. 20 shows a block diagram of an example computing device in which embodiments of the present invention may be implemented.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

### I. Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

### II. Example Embodiments

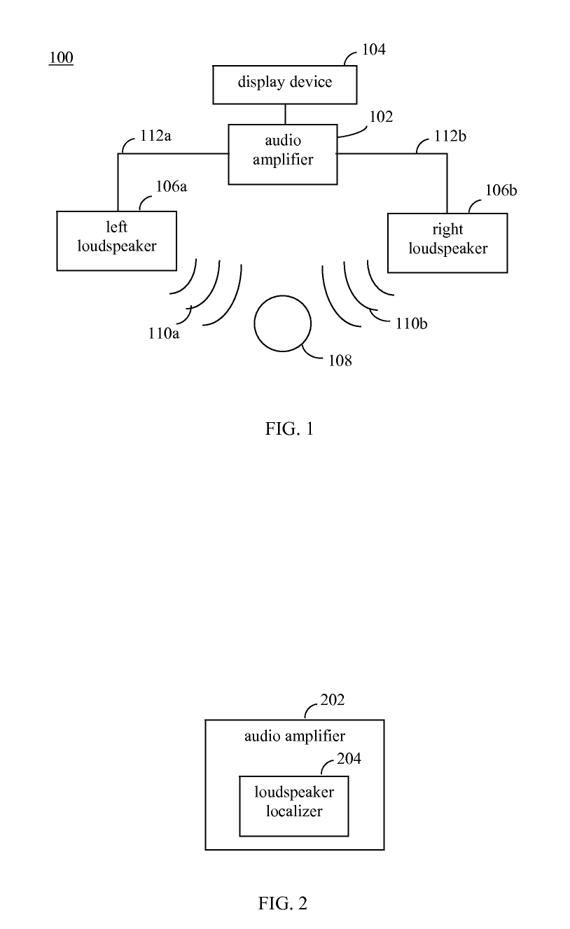

In embodiments, techniques of acoustic source localization are used to determine the locations of loudspeakers, to enable the position of a loudspeaker to be corrected if not positioned properly. For example, FIG. 1 shows a block diagram of a sound system 100. As shown in FIG. 1, sound system 100 includes an audio amplifier 102, a display device 104, a left loudspeaker 106a, and a right loudspeaker 106b. Sound system 100 is configured to generate audio for an audience, such as a user 108 that is located in a listening position. Sound system 100 may be configured in various environments. For example, sound system 100 may be a home audio system in a home of user 108, and user 108 (and optionally further users) may sit in a chair or sofa, or may reside in other listening position for sound system 100. In another example, sound system 100 may be a sound system for a conferencing system in a conference room, and user 108 (and optionally other users) may be a conference attendee that sits at a conference table or resides in other listening position in the conference room.

Audio amplifier 102 receives audio signals from a local device or a remote location, such as a radio, a CD (compact disc) player, a DVD (digital video disc) player, a video game console, a website, a remote conference room, etc. Audio amplifier 102 may be incorporated in a device, such as a conventional audio amplifier, a home theater receiver, a video game console, a conference phone (e.g., an IP (Internet) protocol phone), or other device, or may be separate. Audio amplifier 102 may be configured to filter, amplify, and/or otherwise process the audio signals to be played from left and right loudspeakers 106a and 106b. Any number of loudspeakers 106 may optionally be present in addition to loudspeakers 106a and 106b.

Display device 104 is optionally present when video is provided with the audio played from loudspeakers 106a and 106b. Examples of display device 104 include a standard CRT (cathode ray tube) television, a flat screen television (e.g., plasma, LCD (liquid crystal display), or other type), a projector television, etc.

As shown in FIG. 1, audio amplifier 102 generates a first loudspeaker signal 112a and a second loudspeaker signal 112b. First loudspeaker signal 112a contains first channel audio used to drive first loudspeaker 106a, and second loudspeaker signal 112b contains second channel audio used to drive second loudspeaker 106b. First loudspeaker 106a receives first loudspeaker signal 112a, and produces first sound 110a. Second loudspeaker 106b receives second loudspeaker signal 112b, and produces second sound 110b. First sound 110a and second sound 110b are received by user 108 at the listening position to be perceived as together as an overall sound experience (e.g., as stereo sound), which may coincide with video displayed by display device 104.

For a sufficiently quality audio experience, it may be desirable for left and right loudspeakers 106a and 106b to be positioned accurately. For example, it may be desired for left and right loudspeakers 106a and 106b to be positioned on the proper sides of user 108 (e.g., left loudspeaker 106a positioned on the left, and right loudspeaker 106b positioned on the right). Furthermore, it may be desired for left and right loudspeakers 106a and 106b to positioned equally distant from the listening position on opposite sides of user 108, so that sounds 110a and 110b will be received with substantially equal volume and phase, and such that formed sounds are heard from the intended directions. It may be further desired that any other loudspeakers included in sound system 100 also be positioned accurately.

In embodiments, the positions of loudspeakers are determined, and are enabled to be corrected if sufficiently incorrect (e.g., if incorrect by greater than a predetermined threshold). For instance, FIG. 2 shows a block diagram of an audio amplifier 202, according to an example embodiment. As shown in FIG. 2, audio amplifier 202 includes a loudspeaker localizer 204. Loudspeaker localizer 204 is configured to determine the position of loudspeakers using one or more techniques of acoustic source localization. The determined positions may be compared to desired loudspeaker positions (e.g., in predetermined loudspeaker layout configurations) to determine whether loudspeakers are incorrectly positioned Any incorrectly positioned loudspeakers may be repositioned, either manually (e.g., by a user physically moving a loudspeaker, rearranging loudspeaker cables, modifying amplifier settings, etc.) or automatically (e.g., by electronically modifying audio channel characteristics).

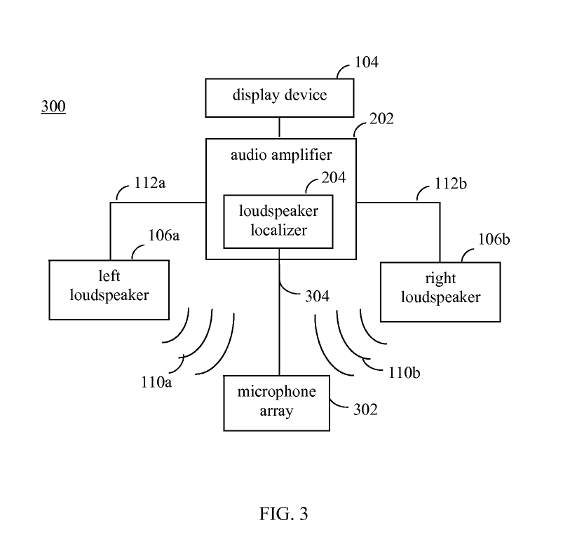

For instance, FIG. 3 shows a block diagram of a sound system 300, according to an example embodiment. Sound system 300 is similar to sound system 100 shown in FIG. 1, with differences described as follows. As shown in FIG. 3, audio amplifier 202 (shown in FIG. 3 in place of audio amplifier 102 of FIG. 1) includes loudspeaker localizer 204, and is coupled (wirelessly or in a wired fashion) to display device 104, left loudspeaker 106a, and right loudspeaker 106b. Furthermore, a microphone array 302 is included in FIG. 3. Microphone array 302 includes one or more microphones that may be positioned in various microphone locations to receive sounds 110a and 110b from loudspeakers 106a and 106b. Microphone array 302 may be a separate device or may be included within a device or system, such as a home theatre system, a VoIP telephone, a BT (Bluetooth) headset/car kit, as part of a gaming system, etc. Microphone array 302 produces microphone signals 304 that are received by loudspeaker localizer 204. Loudspeaker localizer 204 uses microphone signals 304, which are electrical signals representative of sounds 110a and/or 110b received by the one or more microphones of microphone array 302, to determine the location of one or both of left and right loudspeakers 106a and 106b. Audio amplifier 202 may be configured to modify first and/or second loudspeaker signals 112a and 112b provided to left and right loudspeakers 106a and 106b, respectively, based on the determined location(s) to virtually reposition one or both of left and right loudspeakers 106a and 106b.

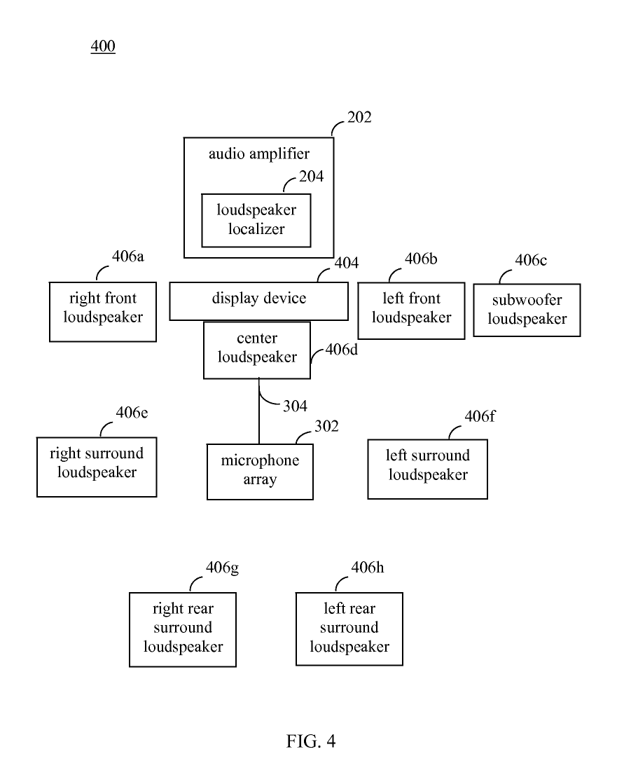

Loudspeaker localizer 204 and microphone array 302 may be implemented in any sound system having any number of loudspeakers, to determine and enable correction of the positions of the loudspeakers that are present. For instance, FIG. 4 shows a block diagram of a sound system 400, according to an example embodiment. Sound system 400 is an example 7.1 channel surround sound system that is configured for loudspeaker localization. As shown in FIG. 4, sound system 400 includes loudspeakers 406a-406h, a display device 404, audio amplifier 202, and microphone array 302. As shown in FIG. 4, audio amplifier 202 includes loudspeaker localizer 204. In FIG. 4, audio amplifier 202 generates two audio channels for left and right front loudspeakers 406a and 406b, one audio channel for a center loudspeaker 406d, two audio channels for left and right surround loudspeakers 406a and 406f, two audio channels for left and right surround loudspeakers 406g and 406h, and one audio channel for a subwoofer loudspeaker 406c. Loudspeaker localizer 204 may use microphone signals 304 that are representative of sound received from one or more of loudspeakers 406a-406h to determine the location of one or more of loudspeakers 406a-406h. Audio amplifier 202 may be configured to modify loudspeaker audio channels (not indicated in FIG. 4 for ease of illustration) that are generated to drive one or more of loudspeakers 406a-406h based on the determined location(s) to virtually reposition one or more of loudspeakers 406a-406h.

Note that the 7.1 channel surround sound system shown in FIG. 4 is provided for purposes of illustration, and is not intended to be limiting. In embodiments, loudspeaker localizer 204 may be included in further configurations of sound systems, including conference room sound systems, stadium sound systems, surround sound systems having different number of channels (e.g., 3.0 system, 4.0 systems, 5.1 systems, 6.1 systems, etc., where the number prior to the decimal point indicates the number of non-subwoofer loudspeakers present, and the number following the decimal point indicates whether a subwoofer loudspeaker is present), etc.

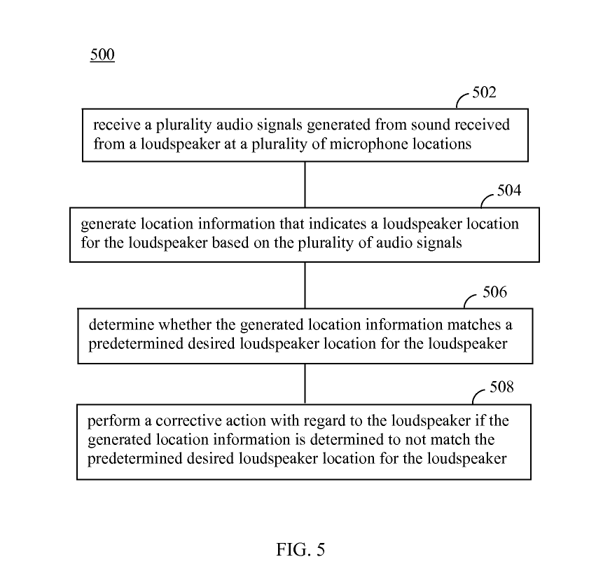

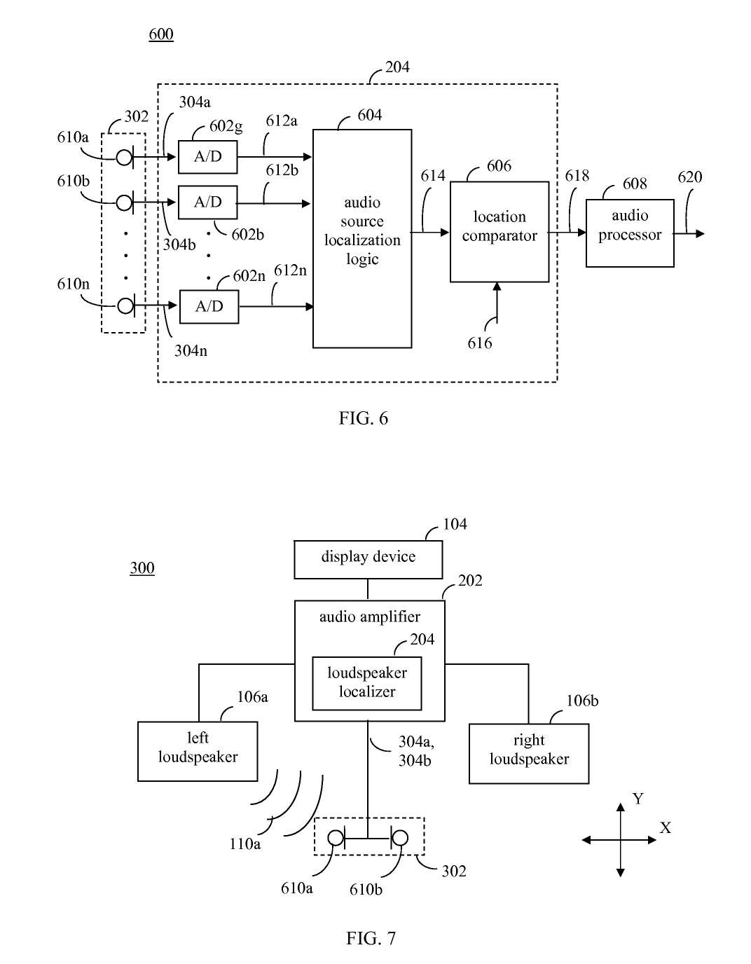

Loudspeaker localization may be performed in various ways, in embodiments. For instance, FIG. 5 shows a flowchart 500 for performing loudspeaker localization, according to an example embodiment. Flowchart 500 may be performed in a variety of systems/devices. For instance, FIG. 6 shows a block diagram of a loudspeaker localization system 600, according to an example embodiment. System 600 shown in FIG. 6 may operate according to flowchart 500, for example. As shown in FIG. 6, system 600 includes microphone array 302, loudspeaker localizer 204, and an audio processor 608. Loudspeaker localizer 204 includes a plurality of A/D (analog-to-digital) converters 602a-602n, audio source localization logic 604, and a location comparator 606. System 600 may be implemented in audio amplifier 202 (FIG. 2) and/or in further devices (e.g., a gaming system, a VoIP telephone, a home theater system, etc.). Further structural and operational embodiments will be apparent to persons skilled in the relevant art(s) based on the discussion regarding flowchart 500. Flowchart 500 and system 600 are described as follows.

Flowchart 500 begins with step 502. In step 502, a plurality of audio signals is received that is generated from sound received from a loudspeaker at a plurality of microphone locations. For example, in an embodiment, microphone array 302 of FIG. 3 may receive sound from a loudspeaker under test at a plurality of microphone locations. Microphone array 302 may include any number of one or more microphones, including microphones 610a-610n shown in FIG. 6. For example, a single microphone may be present that is moved from microphone location to microphone location (e.g., by a user) to receive sound at each of the plurality of microphone locations. In another example, microphone array 302 may include multiple microphones, with each microphone located at a corresponding microphone location, to receive sound at the corresponding microphone location (e.g., in parallel with the other microphones).

In an embodiment, the sound may be received from a single loudspeaker (e.g., sound 110a received from left loudspeaker 106a), or from multiple loudspeakers simultaneously, at a time selected to determine whether the loudspeaker(s) is/are positioned properly. The sound may be a test sound pulse or “ping” of a predetermined amplitude (e.g., volume) and/or frequency, or may be sound produced by a loudspeaker during normal use (e.g., voice, music, etc.). For instance, the position of the loudspeaker(s) may be determined at predetermined test time (e.g., at setup/initialization, and/or at a subsequent test time for the sound system), and/or may be determined at any time during normal use of the sound system.

Microphone array 302 may have various configurations. For instance, FIG. 7 shows a block diagram of sound system 300 of FIG. 3, according to an example embodiment. In FIG. 7, microphone array 302 includes a pair of microphones 610a and 610b. Microphone 610a is located at a first microphone location, and second microphone 610b is located at a second microphone location 610b. Microphones 610a and 610b may be fixed in location relative to each other (e.g., at a fixed separation distance) in microphone array 302 so that microphone array 302 may be moved while maintaining the relative positions of microphones 610a and 610b. In FIG. 7, microphones 610a and 610b are aligned along an x-axis (perpendicular to a y-axis) that is approximately parallel with an axis between right and left loudspeakers 106a and 106b. In the arrangement of FIG. 7, because two microphones 610a and 610b are present and aligned on the x-axis, loudspeaker localizer 204 may determine the locations of loudspeakers 106a and 106b anywhere in the x-y plane, without being able to determine which side of the x-axis that loudspeakers 106a and 106b reside. In other implementations, microphone array 310 of FIG. 7 may be positioned in other orientations, including being perpendicular (aligned with the y-axis) to the orientation shown in FIG. 7.

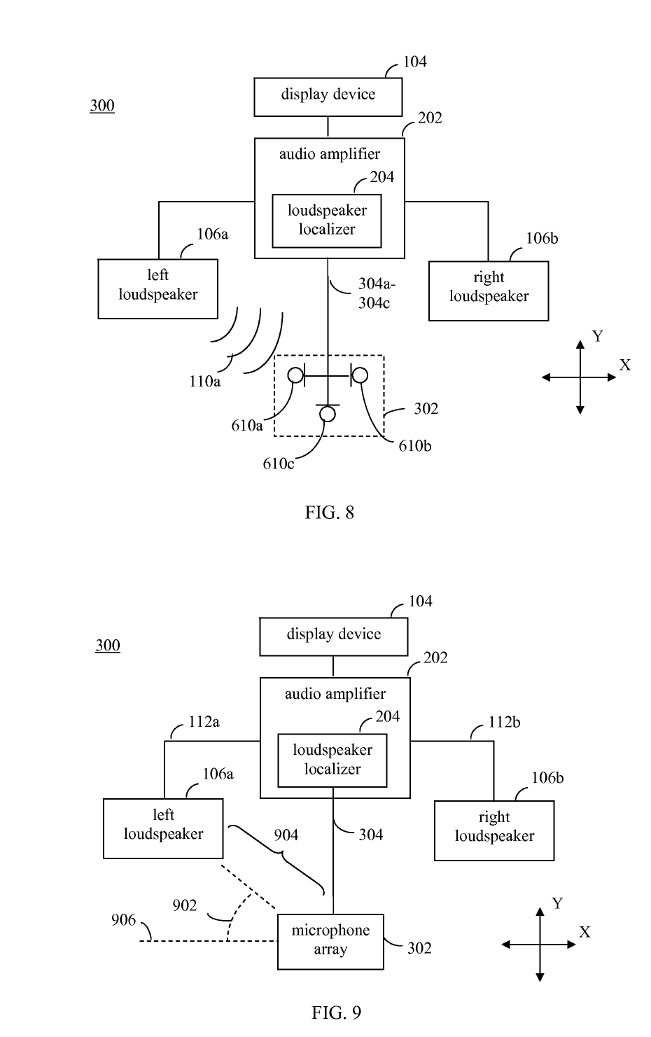

FIG. 8 shows a block diagram of sound system 300 of FIG. 3 that includes another example of microphone array 302, according to an embodiment. In FIG. 8, microphone array 302 includes three microphones 610a-610b. Microphone 610a is located at a first microphone location, second microphone 610b is located at a second microphone location 610b, and third microphone 610c is located at a third microphone location 610c, in a triangular configuration. Microphones 610a-610c may be fixed in location relative to each other (e.g., at fixed separation distances) in microphone array 302 so that microphone array 302 may be moved while maintaining the relative positions of microphones 610a-610c. In FIG. 8, microphones 610a and 610b are aligned along an x-axis (perpendicular to a y-axis) that is approximately parallel with an axis between right and left loudspeakers 106a and 106b, and microphone 610c is offset from the x-axis in the y-axis direction, to form a two-dimensional arrangement. Due to the two-dimensional arrangement of microphone array 302 in FIG. 8, loudspeaker localizer 204 may determine the locations of loudspeakers 106a and 106b anywhere in the 2-dimensional x-y plane, including being able to determine which side of the x-axis, along the y-axis, that loudspeakers 106a and 106b reside.

In other implementations, microphone array 310 of FIG. 8 may be positioned in other orientations, including perpendicular to the orientation shown in FIG. 7 (e.g., microphones 610a and 610b aligned along the y-axis). Note that in further embodiments, microphone array 310 may include further numbers of microphones 610, including four microphones, five microphones, etc. In one example embodiment, microphone array 310 of FIG. 8 may include a fourth microphone that is offset from microphones 610a-610d in a z-axis that is perpendicular to the x-y plane. In this manner, loudspeaker localizer 204 may determine the locations of loudspeakers 106a and 106b anywhere in the 3-dimensional x-y-z space.

Microphone array 310 may be implemented in a same device or separate device from loudspeaker localizer 204. For example, in an embodiment, microphone array 310 may be included in a standalone microphone structure or in another electronic device, such as in a video game console or video game console peripheral device (e.g., the Nintendo® Wii™ Sensor Bar), an IP phone, audio amplifier 202, etc. A user may position microphone array 310 in a location suitable for testing loudspeaker locations, including a location predetermined for the particular sound system loudspeaker arrangement. Microphone array 310 may be placed in a location permanently or temporarily (e.g., just for test purposes).

As shown in FIG. 6, microphone signals 304a-304n from microphones 610a-610n of microphone array 302 are received by A/D converters 602a-602n. Each A/D converter 602 is configured to convert the corresponding microphone signal 304 from analog to digital form, to generate a corresponding digital audio signal 612. As shown in FIG. 6, A/D converters 602a-602n generate audio signals 612a-612n. Audio signals 612a-612n are received by audio source localization logic 604. Note that in an alternative embodiment, A/D converters 602a-602n may be included in microphone array 302 rather than in loudspeaker localizer 204.

Referring back to flowchart 500 in FIG. 5, in step 504, location information that indicates a loudspeaker location for the loudspeaker is generated based on the plurality of audio signals. For example, in an embodiment, audio source localization logic 604 shown in FIG. 6 may be configured to generate location information 614 for a loudspeaker based on audio signals 612a-612n. For example, referring to FIG. 8, audio source localization logic 604 may be configured to generate location information 614 for left loudspeaker 106a based on audio signals 612a-612c (in a three microphone embodiment).

Location information 614 may include one or more location indications, including an angle or direction of arrival indication, a distance indication, etc. For example, FIG. 9 shows a block diagram of sound system 300, with a direction of arrival (DOA) 902 and distance 904 indicated for left loudspeaker 106a. As shown in FIG. 9, distance 904 is a distance between left loudspeaker 106a and microphone array 302. DOA 902 is an angle between left loudspeaker 106a and a base axis 906, which may be any axis through microphone array 302 (e.g., through a central location of microphone array 302, which may be a listening position for a user), including an x-axis, as shown in FIG. 9.

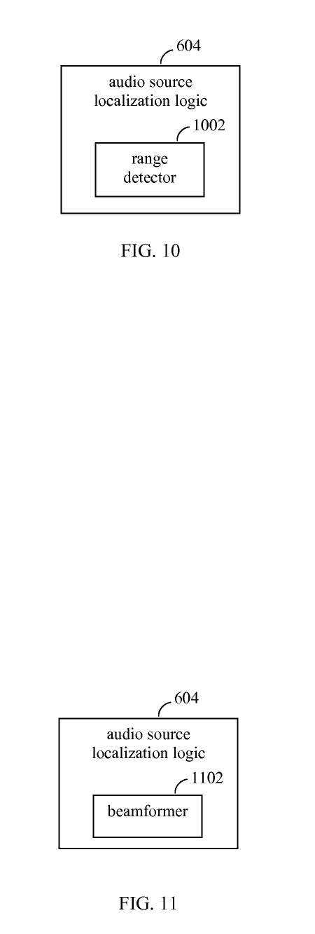

Audio source localization logic 604 may be configured in various ways to generate location information 614 based on audio signals 612a-612n. For instance, FIG. 10 shows a block diagram of audio source localization logic 604 that includes a range detector 1002, according to an example embodiment. Range detector 1002 may be present in audio source localization logic 604 to determine a distance between a loudspeaker and microphone array 302 (e.g., a central point of microphone array 302, which may be a listening position for a user), such as distance 904 shown for left loudspeaker 106a in FIG. 9. Range detector 1002 may be configured to use any sound-based technique for determining range/distance between a microphone array and sound source. For example, range detector 1002 may be configured to cause a loudspeaker to broadcast a sound pulse of known amplitude. Microphone array 302 may receive the sound pulse, and audio signals 612a-612n may be generated based on the sound pulse. Range detector 1002 may compare the broadcast amplitude to the received amplitude for the sound pulse indicated by audio signals 612a-612n to determine a distance between the loudspeaker and microphone array 302. In other embodiments, range detector 1002 may use other microphone-enabled techniques for determining distance, as would be known to persons skilled in the relevant art(s).

FIG. 11 shows a block diagram of audio source localization logic 604 including a beamformer 1102, according to an example embodiment. Beamformer 1102 may be present in audio source localization logic 604 to determine the location of a loudspeaker, including a direction (e.g., DOA 902) and/or a distance (distance 904). Beamformer 1102 is configured to receive audio signals 612 generated by A/D converters 602 and to process audio signals 612 to produce a plurality of responses that correspond respectively to a plurality of beams having different look directions. As used herein, the term “beam” refers to the main lobe of a spatial sensitivity pattern (or “beam pattern”) implemented by beamformer 1102 through selective weighting of audio signals 612. By modifying weights applied to audio signals 612, beamformer 1102 may point or steer the beam in a particular direction, which is sometimes referred to as the “look direction” of the beam.

In one embodiment, beamformer 1102 may determine a response corresponding to each beam by determining a response at each of a plurality of frequencies at a particular time for each beam. For example, if there are n beams, beamformer 310 may determine for each of a plurality of frequencies:

Bᵢ(f,t), for i=1 . . . n, Equation 1

where

Bᵢ(f,t) is the response of beam i at frequency f and time t.

Beamformer 1102 may be configured to generate location information 614 using beam responses in various ways. For example, in one embodiment, beamformer 1102 may be configured to perform audio source localization according to a steered response power (SRP) technique. According to SRP, microphone array 302 is used to steer beams generated using the well-known delay-and-sum beamforming technique so that the beams are pointed in different directions in space (referred to herein as the “look” directions of the beams). The delay-and-sum beams may be spectrally weighted. The look direction associated with the delay-and-sum beam that provides the maximum response power is then chosen as the direction of arrival (e.g., DOA 902) of sound waves emanating from the desired audio source. The delay-and-sum beam that provides the maximum response power may be determined, for example, by finding the index i that satisfies:

$${argmax}_{i} {\sum }_{f} {\vert {B}_{i} ( f , t ) \vert}^{2} \cdot W ( f ) , for i = 1 … n , \qquad Equation 2$$

wherein n is the total number of delay-and-sum beams, Bᵢ(f,t) is the response of delay-and-sum beam i at frequency f and time t, |Bᵢ(f,t)|² is the power of the response of delay-and-sum beam i at frequency f and time t, and W(f) is a spectral weight associated with frequency f. Note that in this particular approach the response power constitutes the sum of a plurality of spectrally-weighted response powers determined at a plurality of different frequencies.

In another embodiment, beamformer 11102 may generate beams using a superdirective beamforming algorithm to acquire beam response information. For example, beamformer 310 may generate beams using a minimum variance distortionless response (MVDR) beamforming algorithm, as would be known to persons skilled in the relevant art(s). Beamformer 310 may utilize further types of beam forming techniques, including a fixed or adaptive beamforming algorithm (such as a fixed or adaptive MVDR beamforming algorithm), to produce beams and corresponding beam responses. As will be appreciated by persons skilled in the relevant art(s), in fixed beamforming, the weights applied to audio signals 612 may be pre-computed and held fixed. In contrast, in adaptive beamforming, the weights applied to audio signals 612 may be modified based on environmental factors.

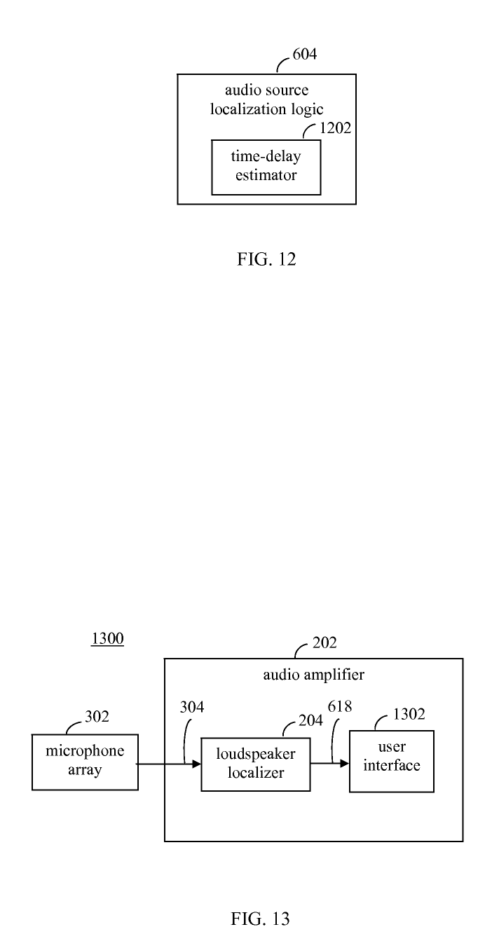

FIG. 12 shows a block diagram of audio source localization logic 604 including a time-delay estimator 1202, according to another example embodiment. Time-delay estimator 1202 may be present in audio source localization logic 604 to determine the location of a loudspeaker, including a direction (e.g., DOA 902) and/or a distance (distance 904). Time-delay estimator 1202 is configured to receive audio signals 612 generated by A/D converters 602 and to process audio signals 612 using cross-correlation techniques to determine location information 614.

For instance, time-delay estimator 1202 may be configured to calculate a cross-correlation, Rᵢⱼ, between each microphone pair (e.g., microphone i and microphone j) of microphone array 302 according to:

$${R}_{ij} ( τ ) = {\int }_{{t}_{0}^{′} - \frac{w}{2}}^{{t}_{0}^{′} + \frac{w}{2}} {x}_{i} ( t ) {x}_{j} ( t - τ ) d t \qquad Equation 3$$

where:

xᵢ is the signal received by the ith microphone,

xⱼ is the signal received by the jth microphone,

w is the width of the integration window,

t′₀ is the approximate time at which the sound was received, and

t₀ is the approximate time at which the sound was generated.

By applying Rᵢⱼ to a range of discrete values, a cross-correlation vector vᵢⱼ of length

$$2 [ \frac{dr}{c} ] + 1 \qquad Equation 4$$

is generated, where d is the distance between the two microphones, r is the sampling rate, and c is the speed of sound. Each element of v indicates the likelihood that the sound source (loudspeaker) is located near a half-hyperboloid centered at the midpoint between the two microphones, with its axis of symmetry the line connecting the two microphones. According to TDE, the location of the loudspeaker (e.g., DOA 902) is estimated using the peaks of the cross-correlation vectors.

Referring back to flowchart 500 in FIG. 5, in step 506, whether the generated location information matches a predetermined desired loudspeaker location for the loudspeaker is determined. For example, in an embodiment, location comparator 606 may determine whether the location of the loudspeaker indicated by location information 614 matches a predetermined desired loudspeaker location for the loudspeaker. For instance, as shown in FIG. 6, location comparator 606 may receive generated location information 614 and predetermined location information 616. Location comparator 606 may be configured to compare generated location information 614 and predetermined location information 616 to determine whether they match, and may generate correction information 618 based on the comparison. If generated location information 614 and predetermined location information 616 do not match (e.g., a difference is greater than a predetermined threshold value), the loudspeaker is determined to be incorrectly positioned, and correction information 618 may indicate a corrective action to be performed.

Predetermined location information 616 may be input by a user (e.g., at a user interface), may be provided electronically from an external source, and/or may be stored (e.g., in storage of loudspeaker localizer 204). Predetermined location information 616 may include position information for each loudspeaker in one or more sound system loudspeaker arrangements. For instance, for a particular loudspeaker arrangement, predetermined location information 616 may indicate a distance and a direction of arrival desired for each loudspeaker with respect to the position of microphone array 302 or other reference location.

In step 508, a corrective action is performed with regard to the loudspeaker if the generated location information is determined to not match the predetermined desired loudspeaker location for the loudspeaker. For example, in an embodiment, audio processor 608 may be configured to enable a corrective action to be performed with regard to the loudspeaker as indicated by correction information 618. As shown in FIG. 6, audio processor 608 receives correction information 618. Audio processor 608 may be configured to enable a corrective action to be performed automatically (e.g., electronically) based on correction information 618 to virtually reposition a loudspeaker. Audio processor 608 may be configured to modify a volume, phase, frequency, and/or other audio characteristic of one or more loudspeakers in the sound system to virtually reposition a loudspeaker that is not positioned correctly.

In an embodiment, audio processor 608 may be an audio processor (e.g., a digital signal processor (DSP)) that is dedicated to loudspeaker localizer 204. In another embodiment, audio processor 608 may be an audio processor integrated in a device (e.g., a stereo amplifier, an IP phone, etc.) that is configured for processing audio, such as audio amplification, filtering, equalization, etc., including any such device mentioned elsewhere herein or otherwise known.

In another embodiment, a loudspeaker may be repositioned manually (e.g., by a user) based on correction information 618. For instance, FIG. 13 shows a block diagram of a loudspeaker localization system 1300, according to an example embodiment. In the example of FIG. 13, audio amplifier 202 includes a user interface 1302. As shown in FIG. 13, correction information 618 is received by user interface 1302 from loudspeaker localizer 204. User interface 1302 is configured to provide instructions to a user to perform the corrective action to reposition a loudspeaker that is not positioned correctly. For example, user interface 1302 may include a display device that displays the corrective action (e.g., textually and/or graphically) to the user. Examples of such corrective actions include instructing the user to physically reposition a loudspeaker, to modify a volume of a loudspeaker, to reconnect/reconfigure cable connections, etc. Instructions may be provided for any number of one or more loudspeakers in the sound system.

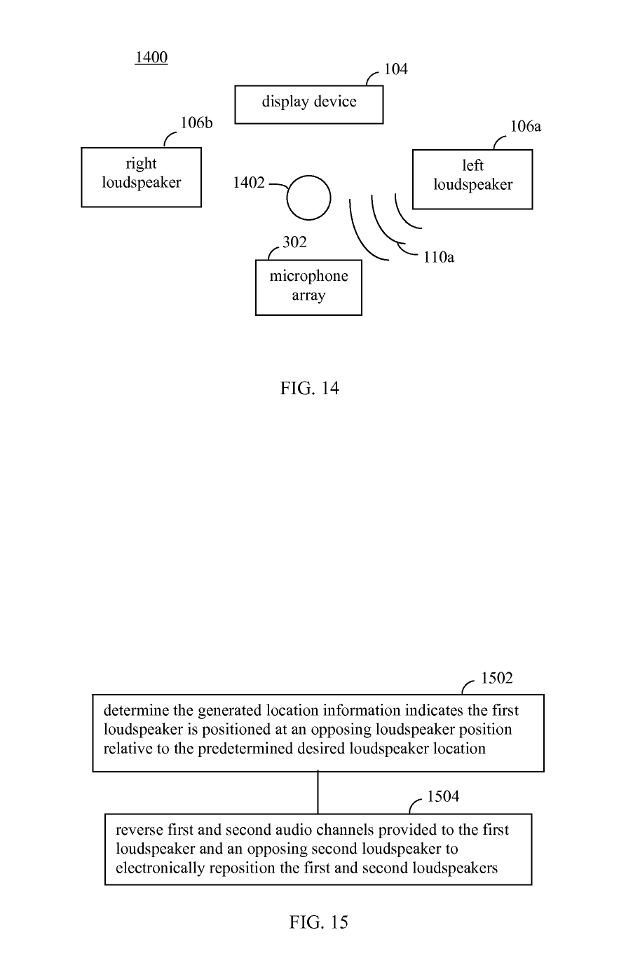

For purposes of illustration, examples of steps 506 and 508 of flowchart 500 are described as follows. For instance, FIG. 14 shows a block diagram of a sound system 1400, where a user has incorrectly placed right loudspeaker 106b on the left side and left loudspeaker 106a on the right side (e.g., relative to a user positioned in a listening position 1402, and facing display device 104). In the example of FIG. 14, when testing the position of left loudspeaker 106a, loudspeaker localizer 204 (not shown in FIG. 14 for ease of illustration) may cause left loudspeaker 106a to output sound 110a. Microphone array 302 receives sound 110a, which is converted to audio signals 612a-612n. Audio signals 612a-612n are received by audio source localization logic 604. Audio source localization logic 604 generates location information 614, which may include a value for DOA 902 indicating that left loudspeaker 106a is positioned to the right (in FIG. 14) of microphone array 302. Location comparator 606 receives location information 614, and compares the value for DOA 902 to a predetermined desired direction of arrival in predetermined location information 616, to generate correction information 618, which indicates that left loudspeaker 106a is incorrectly positioned to the right of microphone array 302. The same test may be optionally performed on right loudspeaker 106b. In any event, in an embodiment, user interface 1302 of FIG. 13 may display correction information 618, indicating to a user to reverse the positions or cable connections of left and right loudspeakers 106a and 106b. In another embodiment, audio processor 608 may be configured to electronically reverse first and second audio channels coupled to left and right loudspeakers 106a and 106b, to correct the mis-positioning of left and right loudspeakers 106a and 106b.

FIG. 15 shows a step 1502 that is an example step 506 of flowchart 500, and a step 1504 that is an example of step 508 of flowchart 500, for such a situation. In step 1502, it is determined that the generated location information indicates the first loudspeaker is positioned at an opposing loudspeaker position relative to the predetermined desired loudspeaker location. In step 1504, first and second audio channels provided to the first loudspeaker and an opposing second loudspeaker are reversed to electronically reposition the first and second loudspeakers.

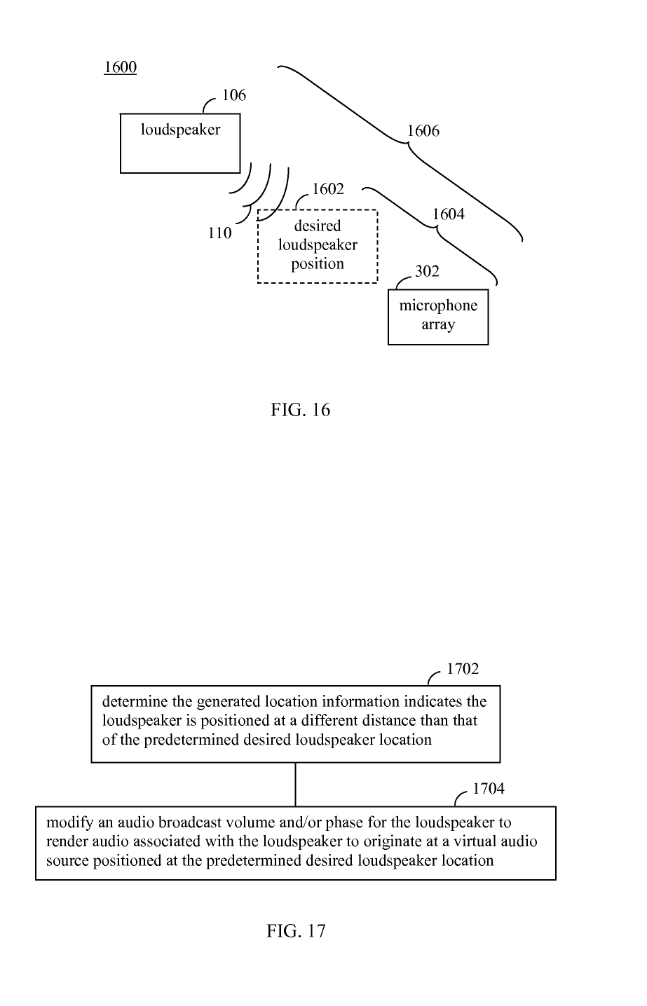

FIG. 16 shows a block diagram of a sound system 1600, where a user has incorrectly placed a loudspeaker 106 farther away from microphone array 302. In the example of FIG. 16, when testing the position of loudspeaker 106, loudspeaker localizer 204 (not shown in FIG. 16 for ease of illustration) may cause loudspeaker 106 to output sound 110. Microphone array 302 receives sound 110, which is converted to audio signals 612a-612n. Audio signals 612a-612n are received by audio source localization logic 604. Audio source localization logic 604 generates location information 614, which may include a value for a distance 1606 between microphone array 302 and loudspeaker 106. Location comparator 606 receives location information 614, and compares the value of distance 1606 to a predetermined desired distance 1604 in predetermined location information 616, to generate correction information 618, which indicates that loudspeaker 106 is incorrectly positioned to too far from microphone array 302 (e.g., by a particular distance). In an embodiment, user interface 1302 of FIG. 13 may display correction information 618, indicating to a user to physically move loudspeaker 106 closer to the location of microphone array 302 by an indicated distance (or to increase a volume of loudspeaker 106 by a determined amount). In another embodiment, audio processor 608 may be configured to electronically increase the volume of the audio channel coupled to loudspeaker 106 to cause loudspeaker 106 to sound as if it is positioned closer to microphone array 302 (e.g., at a virtual loudspeaker location indicated by desired loudspeaker position 1602 in FIG. 16).

In a similar manner, when loudspeaker 106 is too close to the location of microphone array 302, correction information 618 may be generated that indicates loudspeaker 106 needs to be re-positioned (physically or electronically) farther away, or that the volume of loudspeaker 106 needs to be decreased. Furthermore, audio processor 608 may be configured to electronically modify a phase of sound produced by loudspeaker 106 to match a phase of one or more other loudspeakers of the sound system (not shown in FIG. 16), to provide for stereophonic sound, due to the placement of loudspeaker 106 too close or too far from microphone array 302. For example, an audio channel provided to loudspeaker 106 may be delayed to delay the phase of loudspeaker 106, if loudspeaker 106 is located too closely to the location of microphone array 302.

FIG. 17 shows a step 1702 that is an example step 506 of flowchart 500, and a step 1704 that is an example of step 508 of flowchart 500, for such a situation. In step 1702, it is determined that the generated location information indicates the loudspeaker is positioned at a different distance than that of the predetermined desired loudspeaker location. In step 1704, an audio broadcast volume and/or phase for the loudspeaker is modified to render audio associated with the loudspeaker to originate at a virtual audio source positioned at the predetermined desired loudspeaker location.

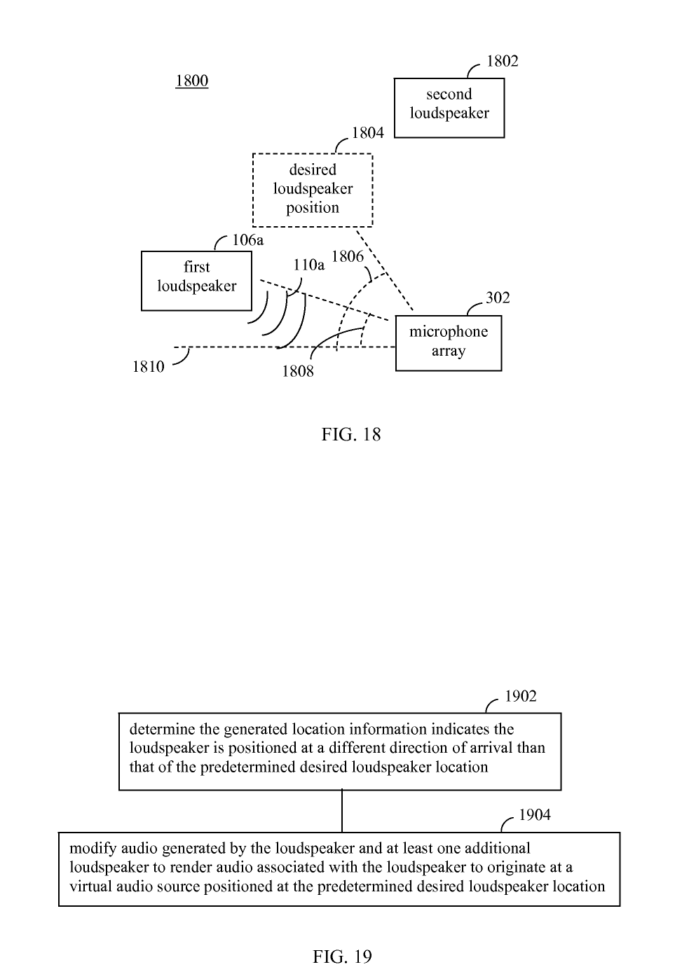

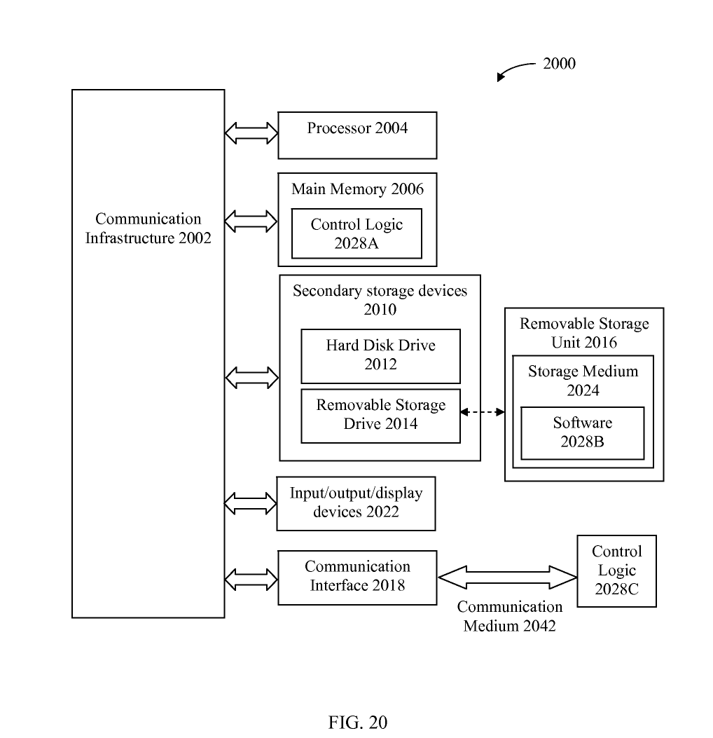

FIG. 18 shows a block diagram of a sound system 1800, where a user has placed a first loudspeaker 106a at an incorrect listening angle from microphone array 302. In the example of FIG. 18, when testing the position of first loudspeaker 106a, loudspeaker localizer 204 (not shown in FIG. 18 for ease of illustration) may cause first loudspeaker 106a to output sound 110a. Microphone array 302 receives sound 110a, which is converted to audio signals 612a-612n. Audio signals 612a-612n are received by audio source localization logic 604. Audio source localization logic 604 generates location information 614, which may include a value for a DOA 1608 for loudspeaker 106a (measured from a reference axis 1810). Location comparator 606 receives location information 614, and compares the value of DOA 1608 to a predetermined desired DOA in predetermined location information 616, indicated in FIG. 18 as desired DOA 1806 (which is an angle to a desired loudspeaker position 1804 from reference axis 1810), to generate correction information 618. Correction information 618 indicates that loudspeaker 106a is incorrectly angled with respect to microphone array 302 (e.g., by a particular difference angle amount). In an embodiment, user interface 1302 of FIG. 13 may display correction information 618, indicating to a user to physically move loudspeaker 106a by a particular amount to desired loudspeaker position 1804. In another embodiment, audio processor 608 may be configured to electronically render audio associated with loudspeaker 106a to appear to originate from a virtual speaker positioned at desired loudspeaker position 1804.

For example, audio processor 608 may be configured to use techniques of spatial audio rendering, such as wave field synthesis, to create a virtual loudspeaker at desired loudspeaker position 1804. According to wave field synthesis, any wave front can be regarded as a superposition of elementary spherical waves, and thus a wave front can be synthesized from such elementary waves. For instance, in the example of FIG. 18, audio processor 608 may modify one or more audio characteristics (e.g., volume, phase, etc.) of first loudspeaker 106a and a second loudspeaker 1802 positioned on the opposite side of desired loudspeaker position 1804 from first loudspeaker 106a to create a virtual loudspeaker at desired loudspeaker position 1804. Techniques for spatial audio rendering, including wave field synthesis, will be known to persons skilled in the relevant art(s).

FIG. 19 shows a step 1902 that is an example of step 506 of flowchart 500, and a step 1904 that is an example of step 508 of flowchart 500, for such a situation. In step 1902, it is determined that the generated location information indicates the loudspeaker is positioned at a different direction of arrival than that of the predetermined desired loudspeaker location. In step 1904, audio generated by the loudspeaker and at least one additional loudspeaker is modified to render audio associated with the loudspeaker to originate at a virtual audio source positioned at the predetermined desired loudspeaker location.

Embodiments of loudspeaker localization are applicable to these and other instances of the incorrect positioning of loudspeakers, including any number of loudspeakers in a sound system. Such techniques may be sequentially applied to each loudspeaker in a sound system, for example, to correct loudspeaker positioning problems. For instance, the reversing of left-right audio in a sound system (as in FIG. 14) is fairly common, particularly with advance sounds systems, such 5.1 or 6.1 surround sound. Embodiments enable such left-right reversing to be corrected, manually or electronically. Sometimes, due to the layout of a room in which a sound system is implemented (e.g., a home theatre room, conference room, etc.), it may be difficult to properly position loudspeakers in their desired positions (e.g., due to obstacles). Embodiments enable mis-positioning of loudspeakers in such cases to be corrected, manually or electronically.

### III. Example Device Implementations

Audio amplifier 202, loudspeaker localizer 204, audio source localization logic 604, location comparator 606, audio processor 608, range detector 1002, beamformer 1102, and time-delay estimator 1202 may be implemented in hardware, software, firmware, or any combination thereof. For example, audio amplifier 202, loudspeaker localizer 204, audio source localization logic 604, location comparator 606, audio processor 608, range detector 1002, beamformer 1102, and/or time-delay estimator 1202 may be implemented as computer program code configured to be executed in one or more processors. Alternatively, audio amplifier 202, loudspeaker localizer 204, audio source localization logic 604, location comparator 606, audio processor 608, range detector 1002, beamformer 1102, and/or time-delay estimator 1202 may be implemented as hardware logic/electrical circuitry.

The embodiments described herein, including systems, methods/processes, and/or apparatuses, may be implemented using well known computing devices/processing devices. A computer 2000 is described as follows as an example of a computing device, for purposes of illustration. Relevant portions or the entirety of computer 2000 may be implemented in an audio device, a video game console, an IP telephone, and/or other electronic devices in which embodiments of the present invention may be implemented.

Computer 2000 includes one or more processors (also called central processing units, or CPUs), such as a processor 2004. Processor 2004 is connected to a communication infrastructure 2002, such as a communication bus. In some embodiments, processor 2004 can simultaneously operate multiple computing threads.

Computer 2000 also includes a primary or main memory 2006, such as random access memory (RAM). Main memory 2006 has stored therein control logic 2028A (computer software), and data.

Computer 2000 also includes one or more secondary storage devices 2010. Secondary storage devices 2010 include, for example, a hard disk drive 2012 and/or a removable storage device or drive 2014, as well as other types of storage devices, such as memory cards and memory sticks. For instance, computer 2000 may include an industry standard interface, such a universal serial bus (USB) interface for interfacing with devices such as a memory stick. Removable storage drive 2014 represents a floppy disk drive, a magnetic tape drive, a compact disk drive, an optical storage device, tape backup, etc.

Removable storage drive 2014 interacts with a removable storage unit 2016. Removable storage unit 2016 includes a computer useable or readable storage medium 2024 having stored therein computer software 2028B (control logic) and/or data. Removable storage unit 2016 represents a floppy disk, magnetic tape, compact disk, DVD, optical storage disk, or any other computer data storage device. Removable storage drive 2014 reads from and/or writes to removable storage unit 2016 in a well known manner.

Computer 2000 also includes input/output/display devices 2022, such as monitors, keyboards, pointing devices, etc.

Computer 2000 further includes a communication or network interface 2018. Communication interface 2018 enables the computer 2000 to communicate with remote devices. For example, communication interface 2018 allows computer 2000 to communicate over communication networks or mediums 2042 (representing a form of a computer useable or readable medium), such as LANs, WANs, the Internet, etc. Network interface 2018 may interface with remote sites or networks via wired or wireless connections.

Control logic 2028C may be transmitted to and from computer 2000 via the communication medium 2042.

Any apparatus or manufacture comprising a computer useable or readable medium having control logic (software) stored therein is referred to herein as a computer program product or program storage device. This includes, but is not limited to, computer 2000, main memory 2006, secondary storage devices 2010, and removable storage unit 2016. Such computer program products, having control logic stored therein that, when executed by one or more data processing devices, cause such data processing devices to operate as described herein, represent embodiments of the invention.

Devices in which embodiments may be implemented may include storage, such as storage drives, memory devices, and further types of computer-readable media. Examples of such computer-readable storage media include a hard disk, a removable magnetic disk, a removable optical disk, flash memory cards, digital video disks, random access memories (RAMs), read only memories (ROM), and the like. As used herein, the terms “computer program medium” and “computer-readable medium” are used to generally refer to the hard disk associated with a hard disk drive, a removable magnetic disk, a removable optical disk (e.g., CDROMs, DVDs, etc.), zip disks, tapes, magnetic storage devices, MEMS (micro-electromechanical systems) storage, nanotechnology-based storage devices, as well as other media such as flash memory cards, digital video discs, RAM devices, ROM devices, and the like. Such computer-readable storage media may store program modules that include computer program logic for audio amplifier 202, loudspeaker localizer 204, audio source localization logic 604, location comparator 606, audio processor 608, range detector 1002, beamformer 1102, time-delay estimator 1202, flowchart 500, step 1502, step 1504, step 1702, step 1704, step 1902, and/or step 1904 (including any one or more steps of flowchart 500), and/or further embodiments of the present invention described herein. Embodiments of the invention are directed to computer program products comprising such logic (e.g., in the form of program code or software) stored on any computer useable medium. Such program code, when executed in one or more processors, causes a device to operate as described herein.

The invention can work with software, hardware, and/or operating system implementations other than those described herein. Any software, hardware, and operating system implementations suitable for performing the functions described herein can be used.

### VI. Conclusion

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents

What is claimed is:

1. A method, comprising:
receiving a plurality audio signals generated from sound received from a loudspeaker at a plurality of microphone locations;
generating location information that indicates a loudspeaker location for the loudspeaker based on the plurality of audio signals;
determining whether the generated location information matches a predetermined desired loudspeaker location for the loudspeaker; and
performing a corrective action with regard to the loudspeaker if the generated location information is determined to not match the predetermined desired loudspeaker location for the loudspeaker.

2. The method of claim 1, wherein said performing comprises:
reversing first and second audio channels between the first loudspeaker and a second loudspeaker.

3. The method of claim 1, wherein said performing comprises:
modifying an audio broadcast volume for the loudspeaker to render audio associated with the loudspeaker to originate at a virtual audio source positioned at the predetermined desired loudspeaker location.

4. The method of claim 1, wherein said performing comprises:
modifying audio generated by the loudspeaker and at least one additional loudspeaker to render audio associated with the loudspeaker to originate at a virtual audio source positioned at the predetermined desired loudspeaker location.

5. The method of claim 1, wherein said performing comprises:
modifying a phase of audio generated by the loudspeaker to enable stereo audio to be received at a predetermined audio receiving location.

6. The method of claim 1, wherein said performing comprises:
providing an indication to a user to physically reposition the loudspeaker.

7. A system, comprising:
at least one microphone;
audio source localization logic that receives a plurality audio signals generated from sound received from a loudspeaker by the at least one microphone at a plurality of microphone locations, wherein the audio source localization logic is configured to generate location information that indicates a loudspeaker location for the loudspeaker based on the plurality of audio signals;
a location comparator configured to determine whether the generated location information matches a predetermined desired loudspeaker location for the loudspeaker; and
an audio processor configured to enable a corrective action to be performed with regard to the loudspeaker if the location comparator determines that the generated location information does not match the predetermined desired loudspeaker location for the loudspeaker.

8. The system of claim 7, wherein if the location comparator determines that the first loudspeaker is positioned at an opposing loudspeaker position relative to the predetermined desired loudspeaker location, the audio processor is configured to reverse first and second audio channels between the first loudspeaker and a second loudspeaker.

9. The system of claim 7, wherein if the location comparator determines that the loudspeaker is positioned at a different distance than that of the predetermined desired loudspeaker location, the audio processor is configured to modify an audio broadcast volume for the loudspeaker to render audio associated with the loudspeaker to originate at a virtual audio source positioned at the predetermined desired loudspeaker location.

10. The system of claim 7, wherein if the location comparator determines that the loudspeaker is positioned at a different direction of arrival than that of the predetermined desired loudspeaker location, the audio processor is configured to modify audio generated by the loudspeaker and at least one additional loudspeaker to render audio associated with the loudspeaker to originate at a virtual audio source positioned at the predetermined desired loudspeaker location.

11. The system of claim 7, wherein if the location comparator determines that the loudspeaker is positioned at a different distance than that of the predetermined desired loudspeaker location, the audio processor is configured to modify a phase of audio generated by the loudspeaker to enable stereo audio to be received at a predetermined audio receiving location.

12. The system of claim 7, wherein if the location comparator determines that the generated location information does not match the predetermined desired loudspeaker location, the audio processor is configured to provide an indication at a user interface to physically reposition the loudspeaker.

13. The system of claim 7, wherein the audio source localization logic includes a beamformer.

14. The system of claim 7, wherein the audio source localization logic includes a time-delay estimator.

15. The system of claim 7, wherein the at least one microphone includes a single microphone that is moved to each of the plurality of microphone locations to receive the sound.

16. The system of claim 7, wherein the at least one microphone includes a plurality of microphones, the plurality of microphones including a microphone positioned at each of the plurality of microphone locations to receive the sound.

17. A computer program product comprising a computer-readable medium having computer program logic recorded thereon for enabling a processor to perform loudspeaker localization, comprising:
first computer program logic means for enabling the processor to generate location information that indicates a loudspeaker location for a loudspeaker based on a plurality of audio signals generated from sound received from the loudspeaker at a plurality of microphone locations;
second computer program logic means for enabling the processor to determine whether the generated location information matches a predetermined desired loudspeaker location for the loudspeaker; and
third computer program logic means for enabling the processor to perform a corrective action with regard to the loudspeaker if the generated location information is determined to not match the predetermined desired loudspeaker location for the loudspeaker.

18. The computer program product of claim 17, wherein said third computer program logic means comprises:
fourth computer program logic means for enabling the processor to reverse first and second audio channels between the first loudspeaker and a second loudspeaker.

19. The computer program product of claim 17, wherein said third computer program logic means comprises:
fourth computer program logic means for enabling the processor to modify an audio broadcast volume or a broadcast phase for the loudspeaker to render audio associated with the loudspeaker to originate at a virtual audio source positioned at the predetermined desired loudspeaker location.

20. The computer program product of claim 17, wherein said third computer program logic means comprises:
fourth computer program logic means for enabling the processor to modify audio generated by the loudspeaker and at least one additional loudspeaker to render audio associated with the loudspeaker to originate at a virtual audio source positioned at the predetermined desired loudspeaker location.
